(19) United States
(12) Patent Application Publication
(10) Pub. No.: US 2007/0047240 A1
(43) Pub. Date: Mar. 1, 2007

(54) Backlight module

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/493,760

(22) Filed: Jul. 27, 2006

(30) Foreign Application Priority Data
Aug. 23, 2005 (TW) 094128828

(51) Int. Cl. F21V 29/00; F21V 17/00; F21V 15/01

(52) U.S. Cl. 362/373; 362/294; 362/374

(57) ABSTRACT

A backlight module includes a back chassis, a third extruding frame, a fourth extruding frame, and an optical component set. The back chassis includes a plate unit, a first extruding frame, and a second extruding frame. The plate unit has a first side, a second side, a third side, and a fourth side. The first extruding frame is disposed on the first side of the plate unit and has a first supporting portion. The second extruding frame is disposed on the second side of the plate unit and has a second supporting portion. The third extruding frame is disposed on the third side of the plate unit. The fourth extruding frame is disposed on the fourth side of the plate unit. The optical component set is disposed on the first supporting portion and the second supporting portion.

### BACKGROUND OF THE INVENTION

1. Field of Invention

The invention relates to a backlight module and, in particular, to a backlight module for a liquid crystal display.

2. Related Art

Liquid crystal displays have been currently used as display screens for typical electronic products widely. Recently, the liquid crystal display is further combined with the video technology to develop a liquid crystal television.

However, the liquid crystal display used in either the display screen or the television is mainly composed of a liquid crystal panel and a backlight module.

Recently, the dimension of the liquid crystal display is getting larger and larger to meet the requirement in the market. Under this requirement, the dimensions of the liquid crystal panel and the backlight module are also increased. In the usage of the liquid crystal television, the current requirement in the market has been advanced to the dimension over 32 inches.

However, when the dimension of the backlight module is increased, the problem coming therewith is the increase of cost. The main reason is that some components of the backlight module have too much material waste. In addition, because the dimension of the backlight module is increased, the structure intensity thereof has to be enhanced. The enhancement of the structure intensity usually increases the number of elements or the number of assembling procedures. Thus, the cost is also increased.

The drawbacks of the prior art backlight module will be described with reference to FIG. 1.

As shown in FIG. 1, the conventional backlight module mainly includes a backpanel 11, a plurality of light sources 12, two side frames 13 and 14, an inner frame 15, an optical component set 16, and an outer frame 17.

The backpanel 11 of the conventional backlight module is constituted by a thin metal plate, which does not have a good intensity. Thus, a rectangular frame body has to be constituted by the inner frame 15 and the two side frames 13 and 14 and then the frame body is combined with the outer frame 17 in order to enhance the structure intensity thereof. In addition, in order to make the inner frame 15 and the outer frame 17 have the better reinforced structure effect, the manufacturer usually uses a complete metal sheet and the middle portion of the metal sheet is pressed out such that the inner frame 15 or the outer frame 17 is integrally formed. The pressed middle portion is usually treated as the waste material. Thus, the material cost cannot be reduced. Symbol 171 in FIG. 1 denotes the pressed middle portion of the outer frame 17. In other words, the middle portion 171 is the waste material after the outer frame 17 is formed.

As mentioned hereinabove, the manufacturer starts to utilize the frame body assembling method in order to reduce the material waste. However, the frame body is made by way of assembling, the structure intensity thereof is poor, and the assembling cost is increased.

In addition, the two side frames 13 and 14 of the conventional backlight module are usually plastic frame bodies, which form poor effect against EMI together with the backpanel 11. In order to solve this problem, an additional metal shielding element has to be used. Furthermore, because the backpanel 11 is constituted by the thin metal plate, a thicker metal casing has to be attached to the thin metal plate when the liquid crystal display has to be equipped with a foot (not shown). Thus, the cost thereof cannot be reduced.

Consequently, it is an important subject of the invention to provide a backlight module with a low cost, a good structure and the function of preventing electromagnetic interference.

### SUMMARY OF THE INVENTION

In view of the foregoing, the invention is to provide a backlight module with a low cost, a good structure and the function of preventing electromagnetic interference.

To achieve the above, the invention discloses a backlight module including a back chassis, a third extruding frame, a fourth extruding frame and an optical component set. The back chassis includes a plate unit, a first extruding frame and a second extruding frame. The plate unit has a first side, a second side, a third side and a fourth side. The first extruding frame is disposed on the first side of the plate unit and has a first supporting portion. The second extruding frame is disposed on the second side of the plate unit and has a second supporting portion. The third extruding frame is disposed on the third side of the plate unit. The fourth extruding frame is disposed on the fourth side of the plate unit. The optical component set is disposed on the first supporting portion and the second supporting portion.

As mentioned above, because the backlight module of the invention is mainly composed of the first extruding frame, the second extruding frame and the plate unit, the structure intensity thereof is very good. Because the good structure intensity is obtained, it is unnecessary to use the inner frame and the outer frame in the conventional backlight module, the complicated assembling processes may be avoided, and the cost can be greatly reduced. In addition, because the backlight module according to the invention is mainly composed of the first extruding frame, the second extruding frame and the plate unit, the module is a complete metal casing and thus has the good effect against EMI. In addition, because the backlight module according to the invention has very good structure intensity, the plate unit of each of the backlight module and the back chassis may be directly connected to an external base without any casing for reinforcement. Thus, the cost may be greatly reduced.

### BRIEF DESCRIPTION OF THE DRAWINGS

The invention will become more fully understood from the detailed description given herein below illustration only, and thus is not limitative of the present invention, and wherein:

FIG. 1 is a schematically exploded view showing a main portion of a conventional backlight module;

FIG. 2a is a schematic illustration showing a back chassis of a backlight module according to a preferred embodiment of the invention;

FIG. 2b is a schematically cross-sectional view taken along a line A-A of the back chassis of FIG. 2a;

FIG. 3a is a schematic illustration showing another back chassis of the backlight module according to the preferred embodiment of the invention;

FIG. 3b is a schematically cross-sectional view taken along a line B-B of the back chassis of FIG. 3a;

FIG. 4 is a schematic illustration showing still another back chassis of the backlight module according to the preferred embodiment of the invention;

FIG. 5a is a cross-sectional view showing a back chassis of the backlight module having a first connecting portion and a second connecting portion according to the preferred embodiment of the invention;

FIG. 5b is a cross-sectional view showing another back chassis of the backlight module having a first connecting portion and a second connecting portion according to the preferred embodiment of the invention;

FIG. 5c is a cross-sectional view showing still another back chassis of the backlight module having a first connecting portion and a second connecting portion according to the preferred embodiment of the invention;

FIG. 6a is a cross-sectional view showing the back chassis of the backlight module having the first connecting portion and the second connecting portion according to the embodiment of the invention, wherein the plate unit includes two flat plates;

FIG. 6b is a cross-sectional view showing another back chassis of the backlight module having the first connecting portion and the second connecting portion according to the embodiment of the invention, wherein the plate unit includes two flat plates;

FIG. 6c is a cross-sectional view showing still another back chassis of the backlight module having the first connecting portion and the second connecting portion according to the embodiment of the invention, wherein the plate unit includes two flat plates;

FIG. 7a is a schematic illustration showing yet still another back chassis of the backlight module according to the preferred embodiment of the invention;

FIG. 7b is a schematically cross-sectional view taken along a line C-C of the back chassis of FIG. 7a;

FIG. 8a is a schematic illustration showing yet still another back chassis of the backlight module according to the preferred embodiment of the invention;

FIG. 8b is a schematically cross-sectional view taken along a line D-D of the back chassis of FIG. 8a;

FIG. 9 is a schematic illustration showing yet still another back chassis of the backlight module according to the preferred embodiment of the invention;

FIG. 10 is a schematically assembled view showing the back chassis, the third extruding frame and the fourth extruding frame of the backlight module according to the preferred embodiment of the invention;

FIG. 11a is a partially exploded cross-sectional view showing the backlight module according to the preferred embodiment of the invention;

FIG. 11b is an assembled cross-sectional view showing the main parts of the backlight module according to the preferred embodiment of the invention; and

FIG. 12 is an assembled cross-sectional view showing the main parts of another backlight module according to the preferred embodiment of the invention;

FIG. 13 is another assembled cross-sectional view showing the main parts of another backlight module according to the preferred embodiment of the invention; and

FIG. 14 is still another assembled cross-sectional view showing the main parts of another backlight module according to the preferred embodiment of the invention.

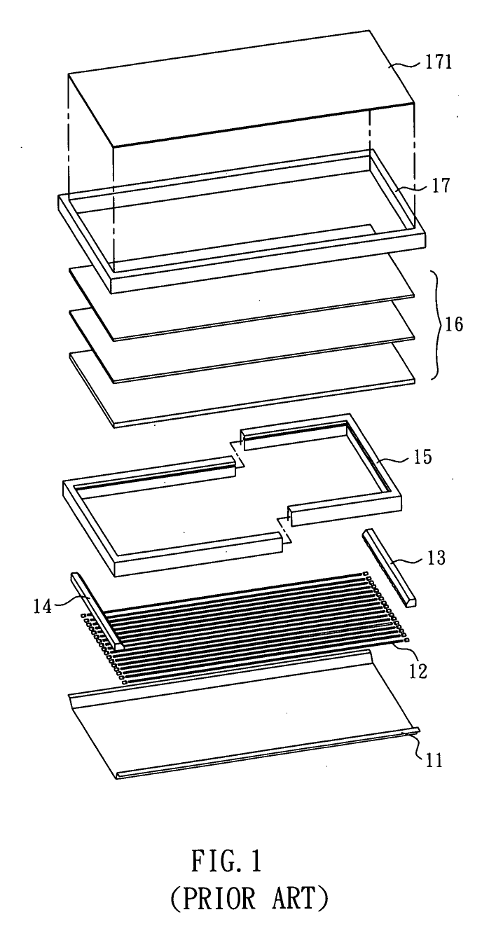

### DETAILED DESCRIPTION OF THE INVENTION

The present invention will be apparent from the following detailed description, which proceeds with reference to the accompanying drawings, wherein the same references relate to the same elements.

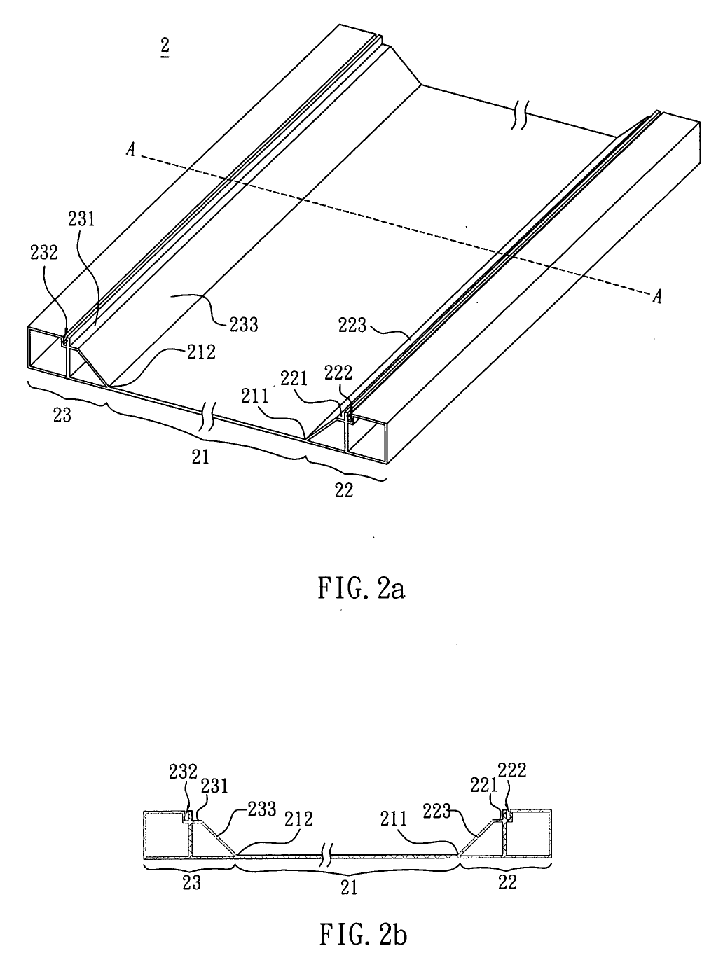

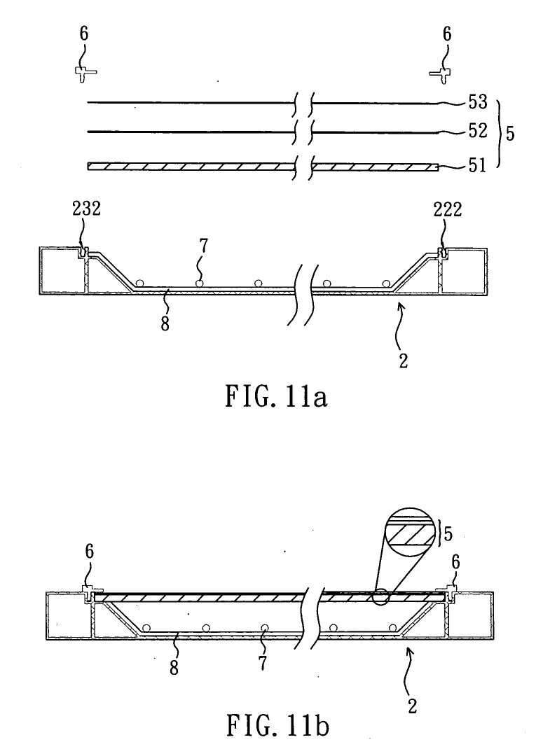

Referring to FIGS. 2a and 2b, a back chassis 2 according to the preferred embodiment of the invention includes a plate unit 21, a first extruding frame 22 and a second extruding frame 23. The plate unit 21 has a first side 211 and a second side 212. In this embodiment, the first side 211 and the second side 212 are opposite sides. The first extruding frame 22 is disposed on the first side 211 of the plate unit 21 and has a first supporting portion 221 for supporting an optical component set 5 (see FIG. 11a). The second extruding frame 23 is disposed on the second side 212 of the plate unit 21 and has a second supporting portion 231 for supporting the optical component set 5 (see FIG. 11a).

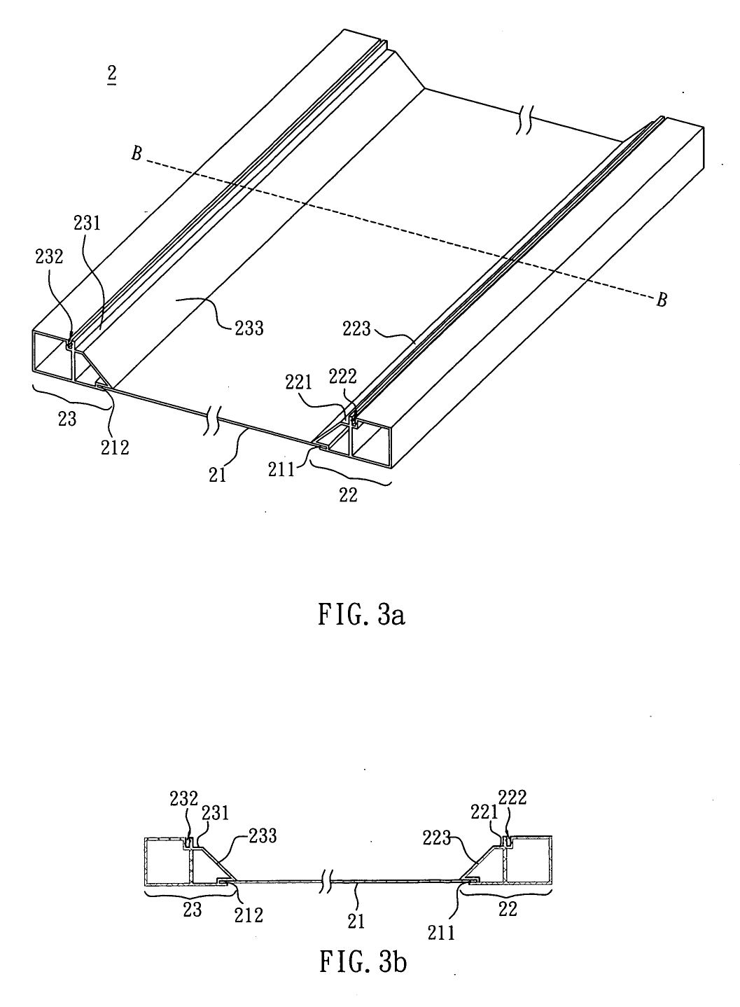

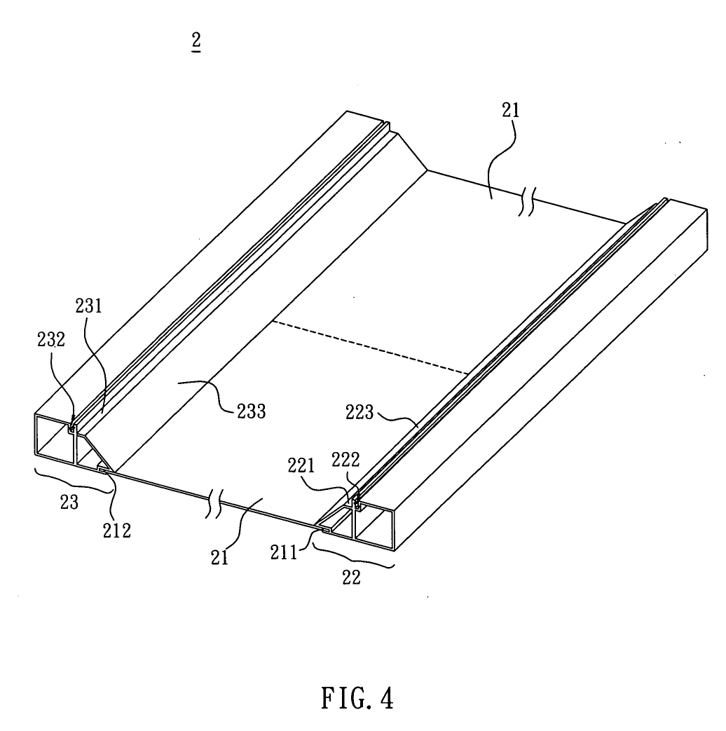

Also, as shown in FIGS. 2a and 2b, the plate unit 21, the first extruding frame 22 and the second extruding frame 23 of the back chassis 2 are integrally formed by way of aluminum extruding or aluminum alloy extruding. Of course, as shown in FIGS. 3a and 3b, the back chassis 2 may also include a flat plate serving as the plate unit 21, and the first extruding frame 22 and the second extruding frame 23 formed by way of aluminum extruding or aluminum alloy extruding. As shown in FIGS. 3a and 3b, the plate unit 21 is a flat plate, and the first side 211 and the second side 212 of the plate unit 21 are respectively engaged with the first extruding frame 22 and the second extruding frame 23. It is to be specified that the plate unit 21 may further include two or more than two flat plates engaging with the first extruding frame 22 and the second extruding frame 23 in parallel in a larger back chassis, as shown in FIG. 4.

In addition, as shown in FIGS. 2a and 2b, or FIGS. 3a and 3b, the first extruding frame 22 further has a first locked element 222 to be locked with a locking element 6 (see FIG. 11a) and a first slant plate portion 223 serving as a reflecting surface. The second extruding frame 23 further has a second locked element 232 to be locked with the locking element 6 (see FIG. 11a) and a second slant plate portion 233 serving as a reflecting surface.

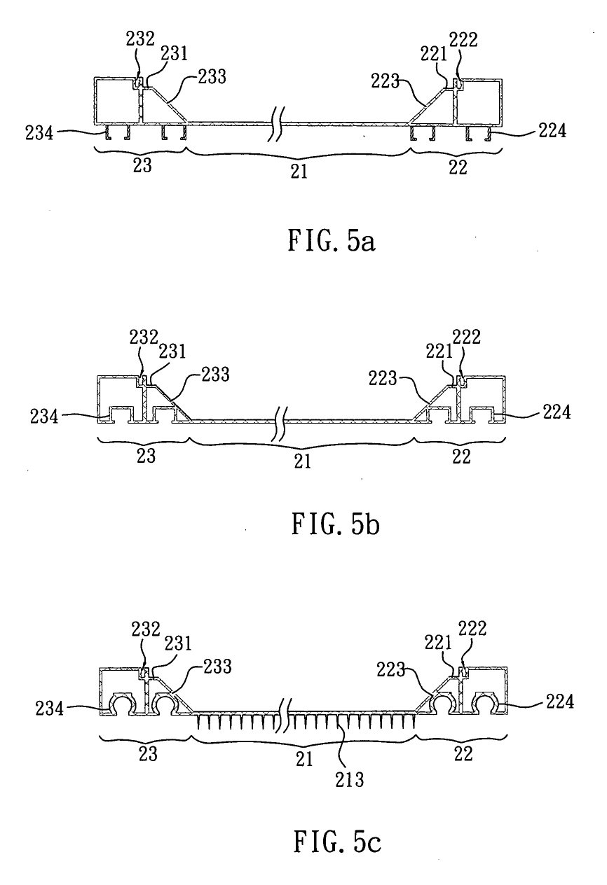

Referring additionally to FIGS. 5a to 5c, the first extruding frame 22 and the second extruding frame 23 may further have a first connecting portion 224 and a second connecting portion 234. The first connecting portion 224 and the second connecting portion 234 of FIG. 5a are convex outwards, while the first connecting portion 224 and the second connecting portion 234 of FIG. 5b and FIG. 5c are concave inwards. The first connecting portion 224 and the second connecting portion 234 may be connected to external elements. In addition, as shown in FIG. 5c, a plurality of heat sinks 213 for dissipating heat may further be formed on a surface of the plate unit 21.

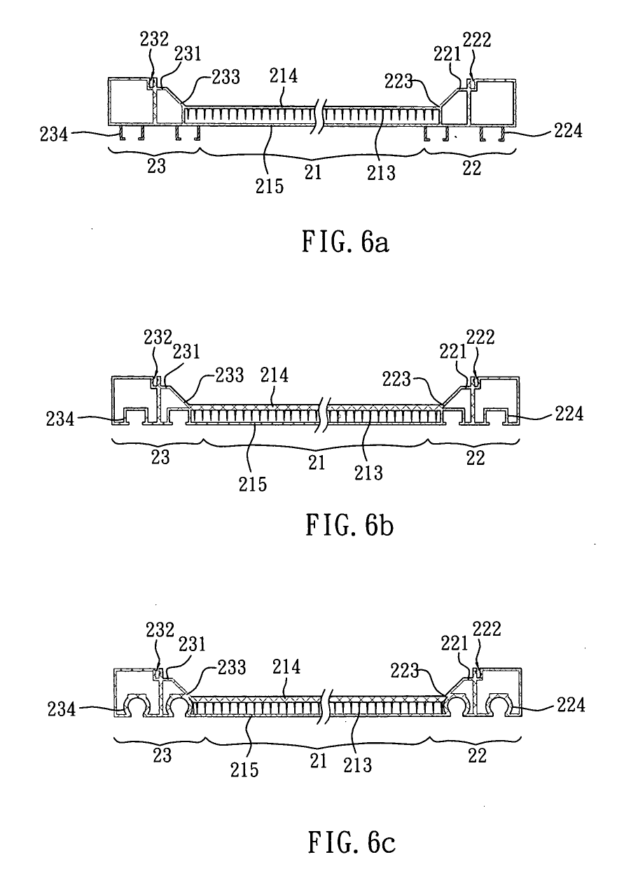

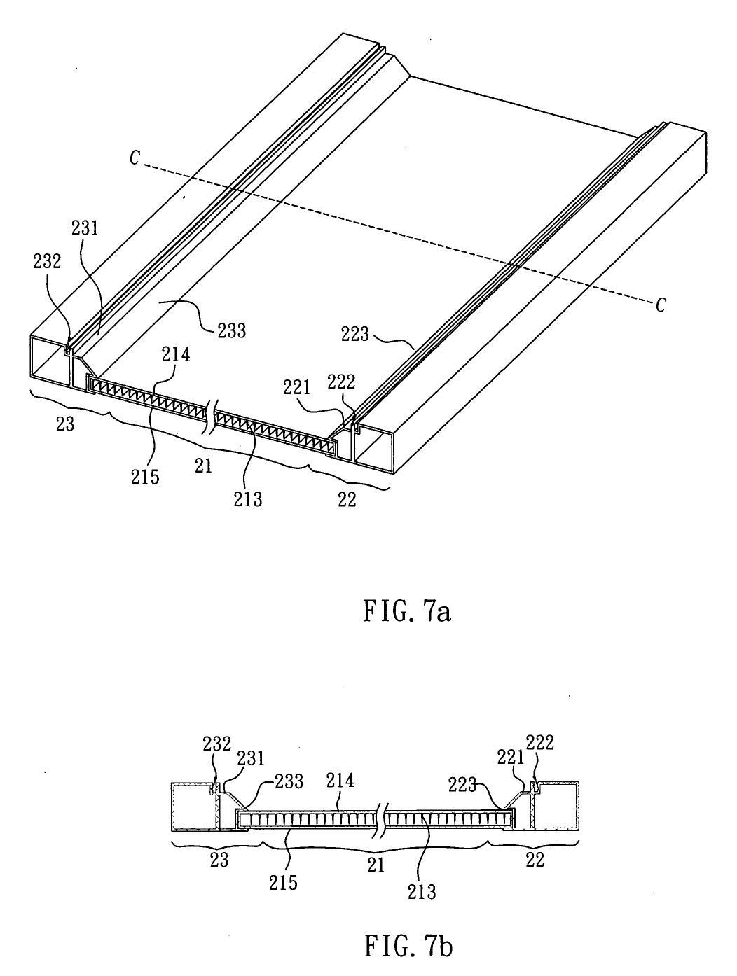

As shown in FIGS. 6a to 6c, the plate unit 21 of back chassis 2 of the invention may also include a first flat plate 214 and a second flat plate 215, which are disposed in parallel with each other. A plurality of heat sinks 213 for dissipating heat may be disposed between the first flat plate 214 and the second flat plate 215. Herein, it is to be specified that the plate unit 21 of FIGS. 6a to 6c is a multi-layer structure, which is integrally formed with the first extruding frame 22 and the second extruding frame 23. However, as shown in FIGS. 7a and 7b, the plate unit 21 may also have a dual-layer structure having two sides respectively locked with the first extruding frame 22 and the second extruding frame 23.

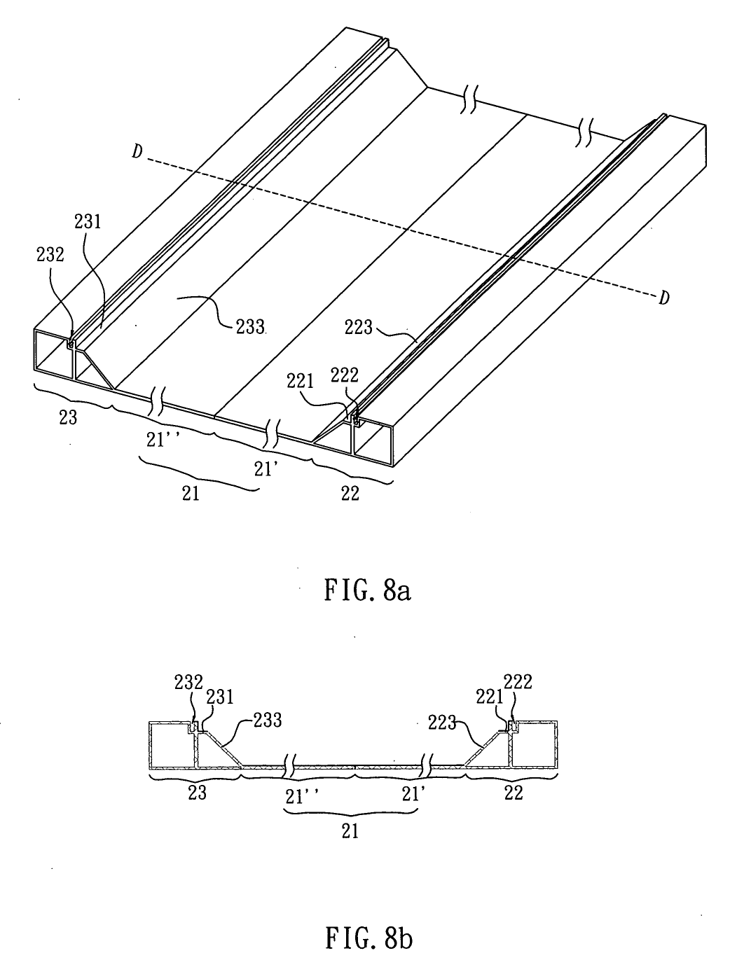

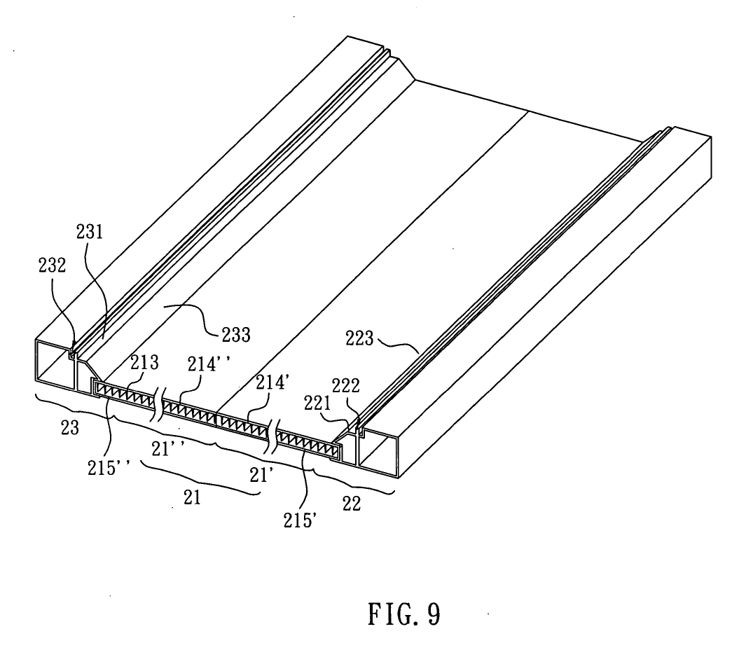

Furthermore, as shown in FIGS. 8a and 8b, the plate unit 21 may further include a first secondary plate unit 21′ and a second secondary plate unit 21″. The first secondary plate unit 21′ and the second secondary plate unit 21″ are disposed horizontally and parallel to each other. As shown in FIGS. 8a and 8b, the first secondary plate unit 21′ and the first extruding frame 22 are integrally formed, and the second secondary plate unit 21″ and the second extruding frame 23 are integrally formed. Of course, each of the first secondary plate unit 21′ and the second secondary plate unit 21″ may also be a flat plate to be combined with the first extruding frame 22 and the second extruding frame 23, respectively in a modified implementation. In addition, referring to FIG. 9, the first secondary plate unit 21′ of the plate unit 21 may also include a third flat plate 214′ and a fourth flat plate 215′, which are in parallel with each other. The second secondary plate unit 21″ includes a fifth flat plate 214″ and a sixth flat plate 215″. The fifth flat plate 214″ and the sixth flat plate 215″ are disposed in parallel to each other. The heat sinks 213 are disposed between the third flat plate 214′ and the fourth flat plate 215′ and between the fifth flat plate 214″ and the sixth flat plate 215″.

In order to facilitate the understanding, the backlight module according to the preferred embodiment of the invention will be described, wherein the same symbols denote the same element of the previous embodiment, and detailed descriptions regarding to the variations of the back chassis may also be omitted.

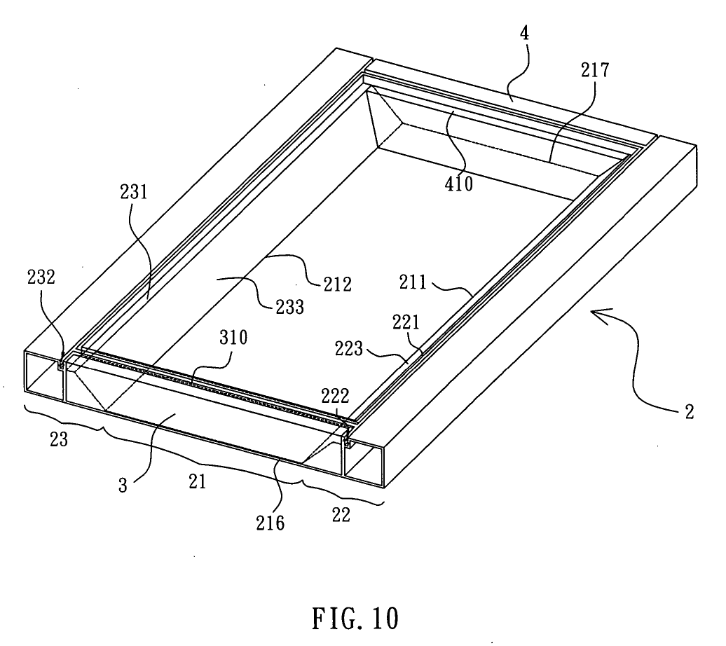

As shown in FIGS. 10, 11a and 11b, the backlight module of the invention includes a back chassis 2, a third extruding frame 3, a fourth extruding frame 4 and an optical component set 5.

The back chassis 2 includes a plate unit 21, a first extruding frame 22 and a second extruding frame 23. The plate unit 21 has a first side 211, a second side 212, a third side 216 and a fourth side 217. The first extruding frame 22 is disposed on the first side 211 of the plate unit 21 and has a first supporting portion 221. The second extruding frame 23 is disposed on the second side 212 of the plate unit 21 and has a second supporting portion 231. The third extruding frame 3 is disposed on the third side 216 of the plate unit 21. The fourth extruding frame 4 is disposed on the fourth side 217 of the plate unit 21. The optical component set 5 is disposed on the first supporting portion 221 and the second supporting portion 231.

As shown in FIG. 10, the third extruding frame 3 and the fourth extruding frame 4 respectively have a third supporting portion 310 and a fourth supporting portion 410. The optical component set 5 may also be disposed on the third supporting portion 310 and the fourth supporting portion 410. In addition, as shown in FIGS. 11a and 11b, the optical component set 5 includes a diffuser 51, a prism sheet 52 or a diffuser sheet 53. As shown in FIGS. 11a and 11b, the backlight module further includes a plurality of locking elements 6 to be locked with the first locked element 222 and the second locked element 232 of the first extruding frame 22 and the second extruding frame 23. Thus, the optical component set 5 can be locked with the first extruding frame 22 and the second extruding frame 23.

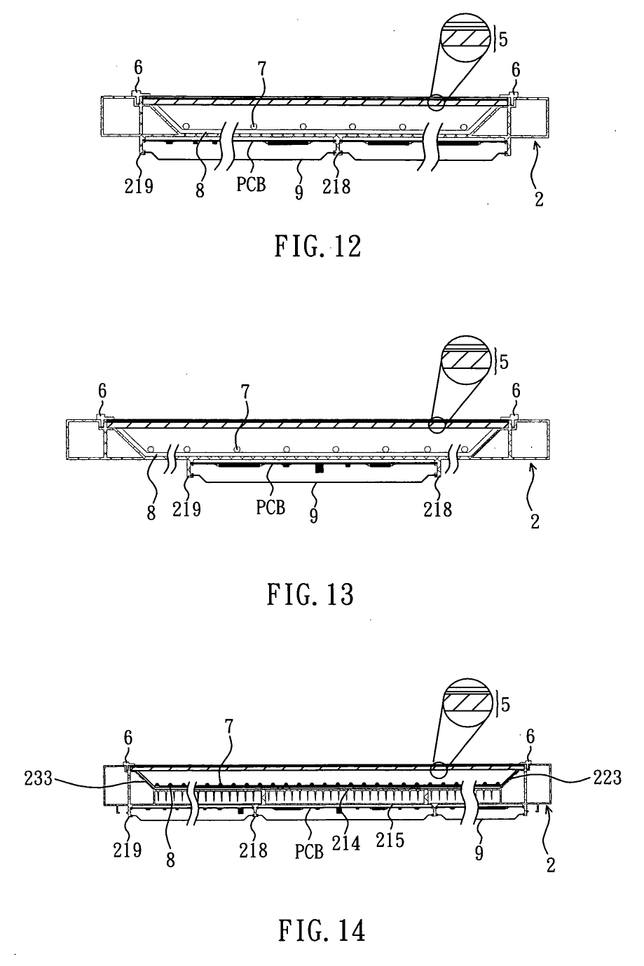

In addition, as shown in FIGS. 12 to 14, the backlight module further includes a plurality of light sources 7. Herein, the light source may be a cold cathode fluorescent lamp (CCFL), as shown in FIGS. 12 and 13, or a light emitting diode (LED), as shown in FIG. 14. At this time, a reflective layer 8 is disposed on each of surfaces of the plate unit 21, the first slant plate portion 223 and the second slant plate portion 233. It is to be specified that the reflective layer 8 is formed on a surface of the plate unit 21 adjacent to the light source 7 when the plate unit 21 is composed of a single flat plate, and the reflective layer 8 is formed on a surface of the first flat plate 214 (see FIG. 14) when the plate unit 21 includes a first flat plate 214 and a second flat plate 215. Of course, when the plate unit 21 is composed of the first secondary plate unit and the second secondary plate unit, the reflective layer 8 is formed on the other surfaces (not shown) of the first secondary plate unit and the second secondary plate unit.

In addition, as shown in FIGS. 12 to 14, the backlight module further includes a shielding plate 9 connected to two connecting portions 218 and 219 of the plate unit 21. Of course, the shielding plate 9 may also be connected to the first connecting portion 224 of the first extruding frame 22 and the second connecting portion 234 (not shown) of the second extruding frame 23. At this time, a circuit board PCB (e.g., a light source drive circuit board or any other system circuit board) may be disposed in a space formed by the connecting portions 218 and 219 of the shielding plate 9 (or by the first connecting portion 224 and the second connecting portion 234). It is to be noted that the shielding plate 9 may also be integrally formed with the two connecting portions 218 and 219 of the plate unit 21 by way of aluminum extruding.

In summary, because the backlight module of the invention is mainly composed of the first extruding frame, the second extruding frame and the plate unit made of the aluminum or the aluminum alloy, the structure intensity thereof is very good. Because the good structure intensity is obtained, it is unnecessary to use the inner frame and the outer frame in the conventional backlight module, the complicated assembling processes may be avoided, and the cost can be greatly reduced. In addition, because the backlight module according to the invention is mainly composed of the first extruding frame, the second extruding frame and the plate unit made of the aluminum or the aluminum alloy, the module is a complete metal casing and thus has the good effect against EMI. In addition, because the backlight module according to the invention has very good structure intensity, the plate unit of each of the backlight module and the back chassis may be directly connected to an external base without any casing for reinforcement. Thus, the cost may be greatly reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module, comprising:
a back chassis comprising a plate unit, a first extruding frame and a second extruding frame, wherein the plate unit has a first side, a second side, a third side and a fourth side, the first extruding frame is disposed on the first side of the plate unit and has a first supporting portion, and the second extruding frame is disposed on the second side of the plate unit and has a second supporting portion;
a third extruding frame disposed on the third side of the plate unit;
a fourth extruding frame disposed on the fourth side of the plate unit; and
an optical component set disposed on the first supporting portion and the second supporting portion.

2. The backlight module according to claim 1, wherein the third extruding flame has a third supporting portion, the fourth extruding frame has a fourth supporting portion, and the optical component set is disposed on the third supporting portion and the fourth supporting portion.

3. The backlight module according to claim 1, wherein the optical component set comprises a diffuser and a prism sheet.

4. The backlight module according to claim 1, wherein the first extruding frame and the second extruding frame are disposed at opposite sides of the plate unit.

5. The backlight module according to claim 1, wherein the plate unit, the first extruding frame and the second extruding frame are integrally formed.

6. The backlight module according to claim 1, wherein each of the first extruding frame and the second extruding frame is an aluminum extruding frame or an aluminum alloy extruding frame.

7. The backlight module according to claim 1, wherein the plate unit is a flat plate, and the plate unit comprises at least one heat sink disposed on a surface of the plate unit, and a reflective layer disposed on another surface of the plate unit.

8. The backlight module according to claim 1, wherein the plate unit comprises a first flat plate and a second flat plate, and the first flat plate and the second flat plate are parallel to each other.

9. The backlight module according to claim 8, wherein the plate unit has at least one heat sink disposed between the first flat plate and the second flat plate, and a reflective layer disposed on a surface of the first flat plate.

10. The backlight module according to claim 1, wherein the plate unit comprises a first secondary plate unit and a second secondary plate unit, and the first secondary plate unit and the second secondary plate unit are disposed horizontally.

11. The backlight module according to claim 10, wherein each of the first secondary plate unit and the second secondary plate unit is a flat plate, and the plate unit has at least one heat sink disposed on a surface of the first secondary plate unit and the second secondary plate unit, and a reflective layer disposed on another surface of the first secondary plate unit and the second secondary plate unit.

12. The backlight module according to claim 10, wherein the first secondary plate unit comprises a third flat plate and a fourth flat plate, the third flat plate and the fourth flat plate are parallel to each other, and the first secondary plate unit has at least one heat sink disposed between the third flat plate and the fourth flat plate, and a reflective layer disposed on a surface of the third flat plate.

13. The backlight module according to claim 10, wherein the second secondary plate unit comprises a fifth flat plate and a sixth flat plate, the fifth flat plate and the sixth flat plate are parallel to each other, and the second secondary plate unit has at least one heat sink disposed between the fifth flat plate and the sixth flat plate, and a reflective layer disposed on a surface of the fifth flat plate.

14. The backlight module according to claim 10, wherein the first secondary plate unit and the first extruding frame are integrally formed.

15. The backlight module according to claim 10, wherein the second secondary plate unit and the second extruding frame are integrally formed.

16. The backlight module according to claim 1, wherein
the first extruding frame further has at least one first locked element and a first slant plate portion, and the first slant plate portion is connected to the plate unit and the first supporting portion; and
the second extruding frame further has at least one second locked element and a second slant plate portion, and the second slant plate portion is connected to the plate unit and the second supporting portion.

17. The backlight module according to claim 16, wherein the backlight module further comprises a plurality of locking elements for locking the first locked element and the second locked element to lock the optical component set with the first extruding frame and the second extruding frame.

18. The backlight module according to claim 1, wherein the first extruding frame further has at least one first connecting portion, and the second extruding frame further has at least one second connecting portion.

19. The backlight module according to claim 1, wherein the backlight module further comprises a shielding plate, and the shielding plate is connected to the plate unit, or connected to the first extruding frame and the second extruding frame.

20. The backlight module according to claim 1, wherein the backlight module further comprises a light source disposed on the back chassis, and the light source is a cold cathode fluorescent lamp (CCFL) or a light-emitting diode (LED).
